(19) United States
(12) Patent Application Publication
(10) Pub. No.: US 2011/0221597 A1
(43) Pub. Date: Sep. 15, 2011

(54) Animal Training Device Having a Programmable Stimulus Delivery Switch

(76) Inventors: James L. Jameson, Seymour, TN (US); Lance Tracy, Oak Ridge, TN (US); Greg Gillis, Escondido, CA (US); Brent A. Goetzl, Orinda, CA (US)

(21) Appl. No.: 12/721,972

(22) Filed: Mar. 11, 2010

(51) Int. Cl. G08B 23/00; A01K 15/02

(52) U.S. Cl. 340/573.3; 119/720

(57) ABSTRACT

Described is an animal training device having a menu-driven user interface, a programmable stimulus delivery switch, and the capability to activate a stimulus delivery device such that it delivers a customized stimulus to an animal. More specifically, the menu-driven user interface enables a user to define the programmable parameters of a customized stimulus and to associate the customized stimulus with the stimulus delivery switch such that when the stimulus delivery switch is operated, the animal training device transmits a stimulus request signal, which includes information indicative of the defined parameters. The stimulus delivery device is responsive to the stimulus request signal to the extent that when the stimulus delivery device receives the stimulus request signal, it determines the defined parameters and delivers the customized stimulus to the animal.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

This invention pertains to a device for training an animal. More particularly, this invention pertains to a device for activation a stimulus delivery device that is carried by an animal and adapted to deliver a stimulus to the animal.

2. Description of the Related Art

Conventional animal training systems typically include a transmitter unit and a receiver unit. The transmitter unit is commonly a handheld device having at least one switch, such as a pressable button. The receiver unit is carried by an animal, is in wireless communication with the transmitter unit, and delivers a stimulus to the animal in response to the switch of the transmitter unit being operated. Some conventional animal training systems include a plurality of switches, whereby each switch corresponds to a particular stimulus. For example, one conventional transmitter unit includes a first switch and a second switch. When the first switch is operated, the receiver unit delivers an electrostatic stimulus to the animal, and when the second switch is operated, the receiver unit delivers an audible stimulus to the animal. In another example, the conventional transmitter unit is in communication with a first receiver unit carried by a first animal and a second receiver unit carried by a second animal. When the first switch is operated, the first receiver unit delivers a stimulus to the first animal. Similarly, when the second switch is operated, the second receiver unit delivers a stimulus to the second animal.

Conventional animal training systems are limited in that the delivered stimuli cannot be adjusted to meet the demands presented by the various characteristics of various animals and various circumstances. Stated differently, the parameters of the stimuli delivered by conventional animal training systems are pre-set at the manufacturing stage and cannot be customized by a user of the system. This limitation is substantial because the size and sensitivity of a given animal is different from another and even varies within the same animal over a period of time. Additionally, certain animals are more responsive to certain types of stimuli and less responsive to others. Consequently, a system that delivers a customized stimulus is desired.

### BRIEF SUMMARY OF THE INVENTION

In accordance with the various features of the present invention, there is provided an animal training device having a menu-driven user interface, a programmable stimulus delivery switch, and the capability to activate a stimulus delivery device such that it delivers a customized stimulus to an animal. Generally, the animal training device includes a display, a menu navigation control, a stimulus delivery switch, and a transmitter. The display is adapted to present a series of menus having menu options, the menu options being related to programmable parameters of the customized stimulus. A user of the animal training device operates the menu navigation control to navigate the menus and to select the menu options, thus defining the programmable parameters. The customized stimulus is associated with the stimulus delivery switch, which is operable by the user. When the stimulus delivery switch is operated, the animal training device transmits a stimulus request signal by way of the transmitter. The stimulus request signal includes information indicative of the defined parameters of the customized stimulus.

The stimulus delivery device is adapted to be carried by the animal, to receive the stimulus request signal, and to deliver the customized stimulus to the animal. When the stimulus delivery device receives the stimulus request signal, it analyzes the signal and determines the defined parameters of the customized stimulus. After determining the defined parameters, the stimulus delivery device delivers the customized stimulus to the animal. As a result, after the stimulus delivery switch is programmed, the user is able to deliver a stimulus that is tailored to a given animal and circumstance to the animal by merely operating the stimulus delivery switch.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a block diagram of one embodiment of the animal training device, along with the stimulus delivery device, in accordance with the various features of the present invention;

FIG. 2a illustrates one embodiment of the animal training device operating in the stimulus delivery mode;

FIG. 2b illustrates one embodiment of the animal training device operating in the stimulus programming mode;

FIG. 2c is another illustration of the animal training device of FIG. 2b operating in the stimulus programming mode;

FIG. 2d is yet another illustration of the animal training device of FIG. 2b operating in the stimulus programming mode; and

FIG. 2e is yet another illustration of the animal training device of FIG. 2b operating in the stimulus programming mode.

### DETAILED DESCRIPTION OF THE INVENTION

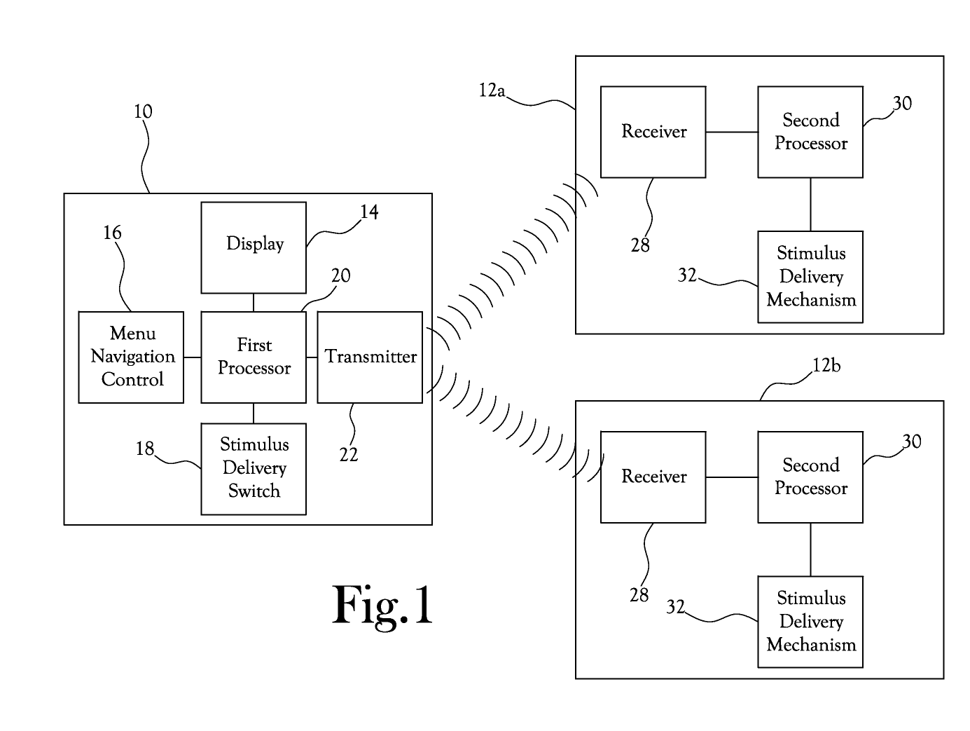

The present invention provides an animal training device having a menu-driven user interface, a programmable stimulus delivery switch, and the capability to activate a stimulus delivery device such that it delivers a customized stimulus to an animal. More specifically, the menu-driven user interface enables a user to define the programmable parameters of a customized stimulus and to associate the customized stimulus with the stimulus delivery switch such that when the stimulus delivery switch is operated, the animal training device transmits a stimulus request signal, which includes information indicative of the defined parameters. The stimulus delivery device is responsive to the stimulus request signal to the extent that when the stimulus delivery device receives the stimulus request signal, it determines the defined parameters and delivers the customized stimulus to the animal. A block diagram of one embodiment of the animal training device constructed in accordance with the various features of the present invention is illustrated generally at 10 in FIG. 1.

FIG. 1 illustrates a block diagram of one embodiment of the animal training device 10, a first stimulus delivery device 12a and a second stimulus delivery device 12b. The animal training device 10 includes a display 14, a menu navigation control 16, a stimulus delivery switch 18, a first processor 20, and a transmitter 22, the first processor 20 being in electrical communication with the display 14, the menu navigation control 16, the stimulus delivery switch 18, and the transmitter 22.

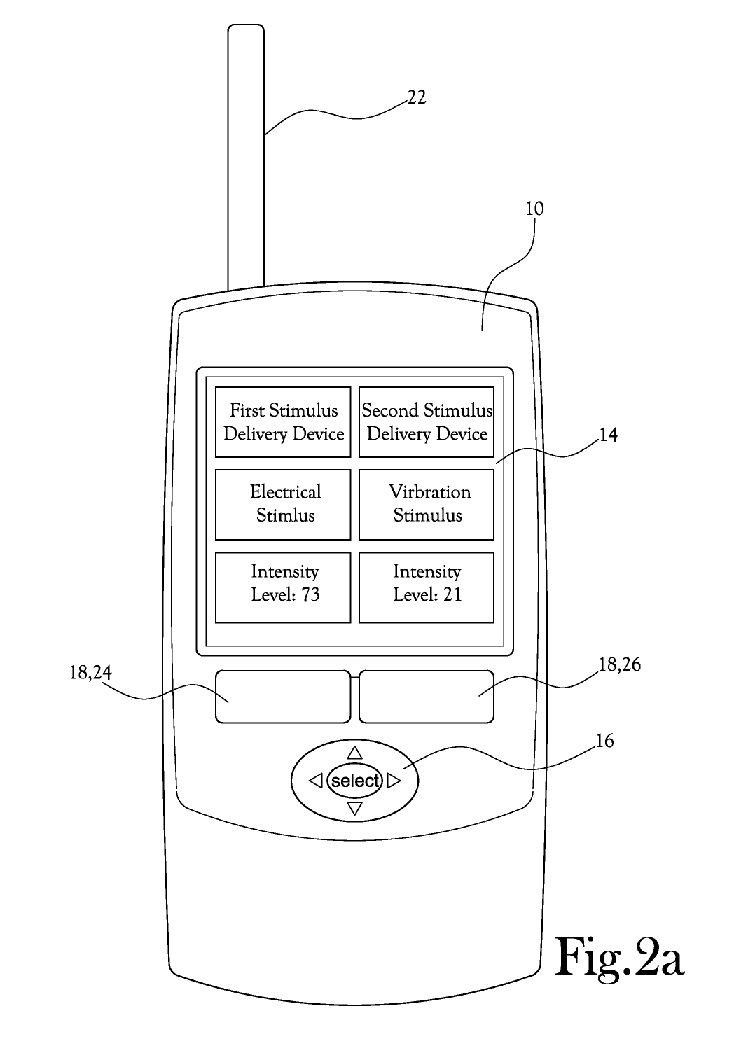

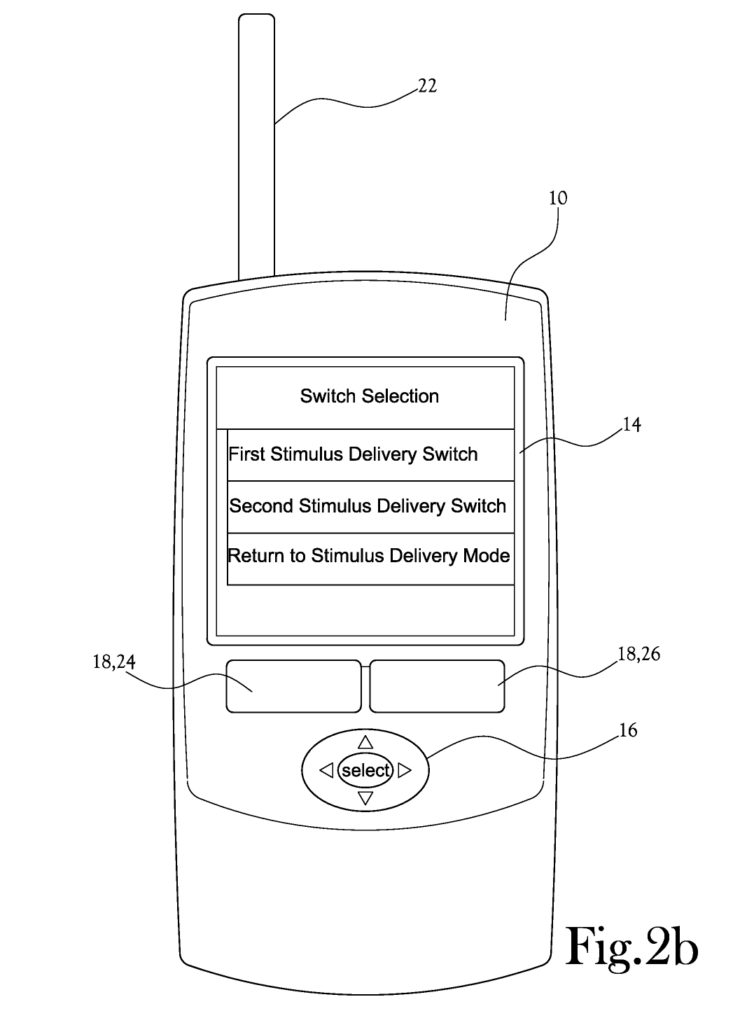

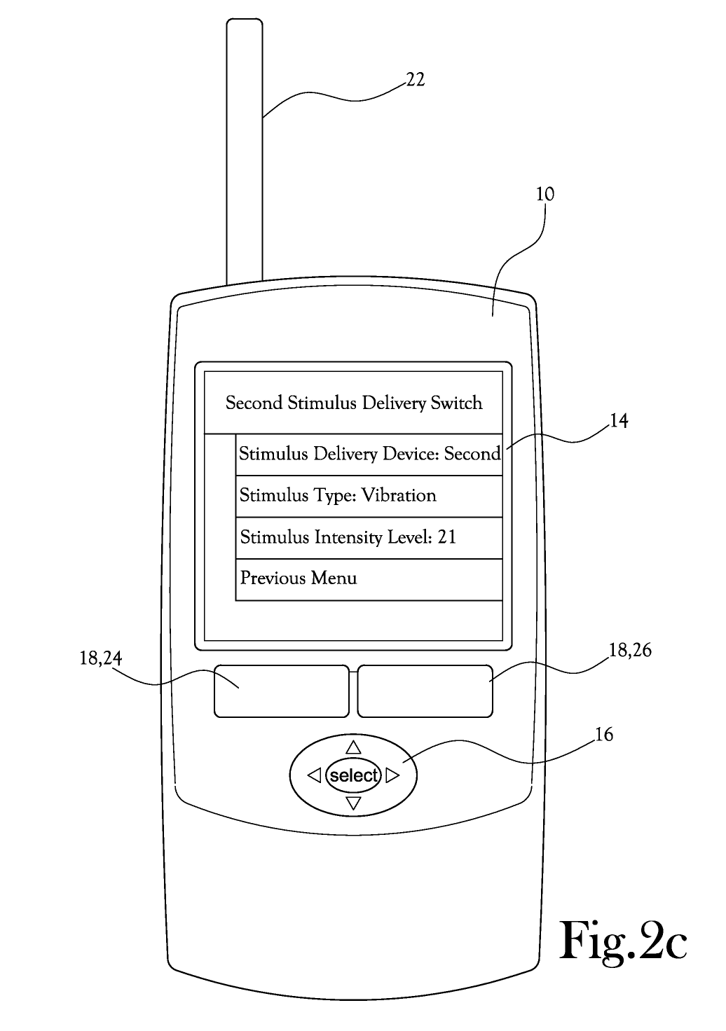

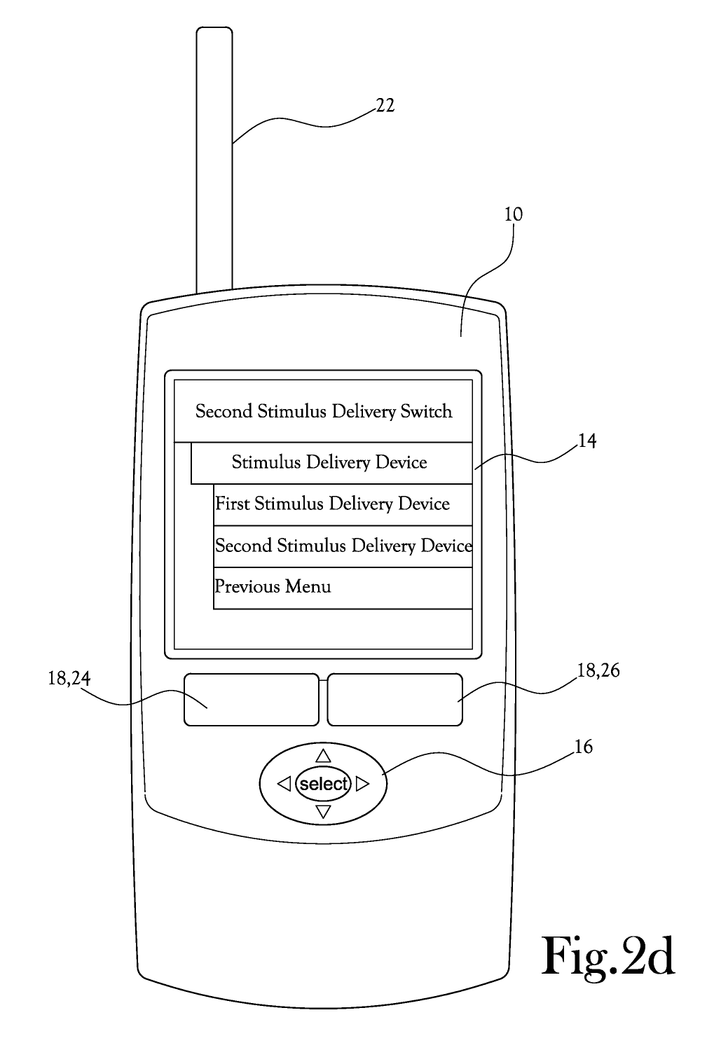

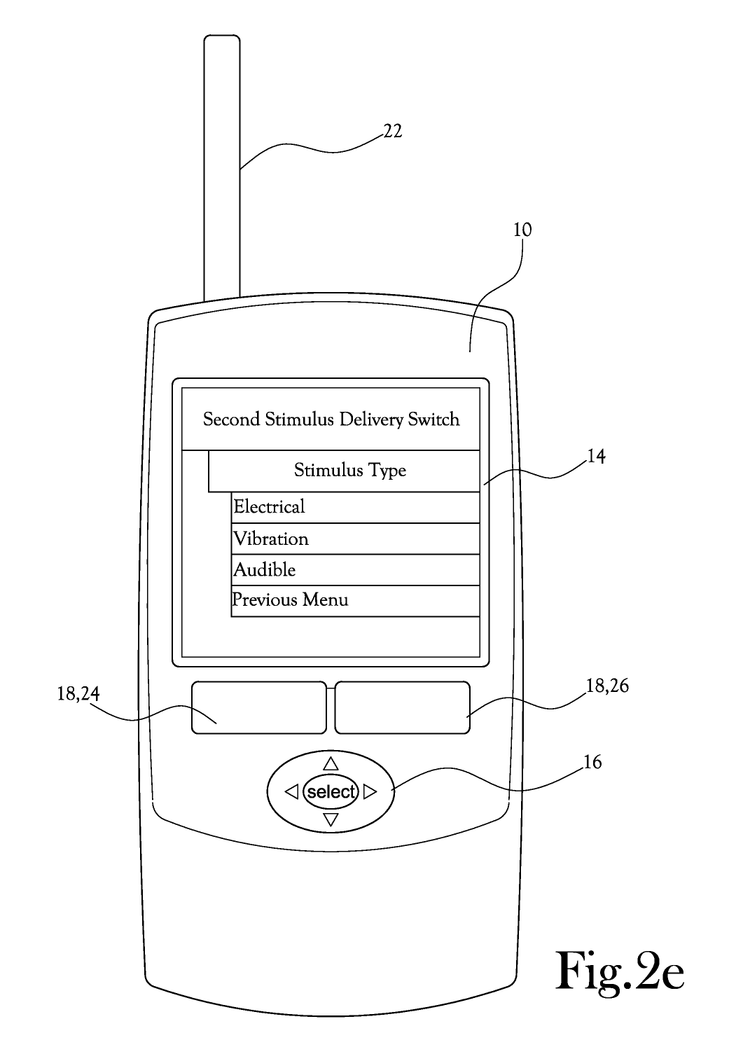

FIGS. 2a-2e illustrate one embodiment of the animal training device 10 in accordance with the various features of the present invention. In the illustrated embodiment, the animal training device 10 is a handheld device adapted to be carried by a user, such as an animal trainer or handler. The display 14 presents a series of menus perceivable and navigable by the user. The menus include selectable menu options, which are related to programmable parameters of a customized stimulus. The user navigates the menus and selects the menu options using the menu navigation control 16. Accordingly, the user defines the parameters of the customized stimulus using the navigation control 16. In the illustrated embodiment, the menu navigation control 16 includes a SELECT key and a directional keypad. However, it should be noted that a menu navigation control 16 other than the illustrated embodiment thereof, such as a touch-screen display, can be used without departing from the scope or spirit of the present invention. It should also be noted that the display 14 can be any display capable of displaying the series of menus, such as a dot matrix display, without departing from the scope or spirit of the present invention.

In the illustrated embodiment, the programmable parameters include the stimulus delivery device 12 to deliver the customized stimulus, the type of the customized stimulus, and the intensity of the customized stimulus. Each customized stimulus is associated with a stimulus delivery switch 18. In the illustrated embodiment, the animal training device 10 includes two stimulus delivery switches 18, namely a first stimulus delivery switch 24 and a second stimulus delivery switch 26. The animal training device 10 operates in at least a stimulus delivery mode and a stimulus programming mode, each mode subsequently discussed in detail. When the stimulus generation unit 10 is operating in the stimulus delivery mode, the display 14 presents the defined parameters of each customized stimulus, as illustrated at FIG. 2a. In the illustrated embodiment, the display 14 presents the defined parameters such that the parameters of each customized stimulus are visually associated with the corresponding stimulus delivery switch 18. More specifically, in the illustrated embodiment, the defined parameters of the customized stimulus corresponding to the first stimulus delivery switch 24 are listed at the display 14 immediately above the first stimulus activation switch 24. Similarly, the defined parameters of the customized stimulus corresponding to the second stimulus delivery switch 26 are listed at the display 14 immediately above the second stimulus activation switch 26. Although the programmable parameters of the illustrated embodiment include three particular parameters, it should be noted that the number and type of the programmable parameters can vary without departing from the scope or spirit of the present invention.

In one embodiment of the animal training device 10, the user switches the mode of operation from the stimulus delivery mode to the stimulus programming mode by pressing the SELECT key of the menu navigation control 16. When the animal training device 10 is operating in the stimulus programming mode, the display 14 presents the previously discussed series of menus, as illustrated at FIGS. 2b-2e. As mentioned above, the user defines the parameters of the customized stimulus by selecting menu options using the menu navigation control 16. For example, in one embodiment, the initial menu presented by the display 14 is the “Switch Selection” menu, illustrated at FIG. 2b. This menu enables the user to select the stimulus delivery switch 18 to be programmed. Consequently, in the illustrated embodiment, the user selects to define the customized stimulus associated with either the first stimulus delivery switch 24 or the second stimulus delivery switch 26 by selecting the “First Stimulus Delivery Switch” option or the “Second Stimulus Delivery Switch” option, respectively. Additionally, in the illustrated embodiment, the “Switch Selection” menu enables the user to switch the mode of operation of the animal training device 10 from the stimulus programming mode to the stimulus delivery mode by selecting the “Return to Stimulus Delivery Mode” option.

After the user selects the stimulus delivery switch 18 to be programmed, the display 14 presents a menu including the programmable parameters of the customized stimulus, as illustrated at FIG. 2c. This menu enables the user to select a parameter for definition. In the illustrated embodiment, the user can select to define the stimulus delivery device 12 to deliver the customized stimulus, the type of the customized stimulus, and intensity of the customized stimulus by selecting the “Stimulus Delivery Device” option, the “Stimulus Type” option, or the “Stimulus Intensity Level” option, respectively. Additionally, in the illustrated embodiment, this menu enables the user to return to the previous menu, namely the “Switch Selection” menu, by selecting the “Previous Menu” option. In the illustrated embodiment, the second stimulus delivery switch 26 is currently selected to be programmed, as is indicated by the uppermost heading, and the current definition for each parameter is presented at its respective menu option. This enables the user to easily reference the current state of the parameters of the customized stimulus.

When the user selects the “Stimulus Delivery Device” option, the display 14 presents a menu including the various stimulus delivery devices 12 operating with the animal training device 10, as illustrated at FIG. 2d. This menu enables the user to select the stimulus delivery device 12 that is to deliver the customized stimulus. Considering the illustrated embodiment, the user selects the first stimulus delivery device 12a or the second stimulus delivery device 12b to deliver the customized stimulus by selecting the “First Stimulus Delivery Device” option or the “Second Stimulus Delivery Device” option, respectfully. Additionally, in the illustrated embodiment, this menu enables the user to return to the previous menu by selecting the “Previous Menu” option. Considering again the menu illustrated at FIG. 2c, when the user selects the “Stimulus Type” option, the display 14 presents a menu including the various stimuli the currently selected stimulus delivery device 12 is capable of delivering, as illustrated at FIG. 2e. This menu enables the user to select the type of stimulus the currently selected stimulus delivery device 12 will deliver. Considering the illustrated embodiment, the user selects an electrical stimulus, a vibration stimulus, or an audible stimulus as the stimulus to be delivered by the second stimulus delivery device by selecting the “Electrical” option, the “Vibration” option, or the “Audible” option, respectfully. Additionally, in the illustrated embodiment, this menu enables the user to return to the previous menu by selecting the “Previous Menu” option. Considering again the menu illustrated at FIG. 2c, when the user selects the “Stimulus Intensity Level” option, the display 14 presents a menu enabling the user to select the intensity of the stimulus to be delivered by the currently selected stimulus delivery device 12 in accordance with the above discussion. As an example, in one embodiment, the user first selects the number of available intensity levels, such as, for example, eight (8) levels. The animal training device 10 then assigns a stimulus intensity to each intensity level such that there is a linear progression of stimulus intensity from level one (1) to level eight (8). After each intensity level is defined, the user selects the desired intensity level of the customized stimulus.

It should be noted that the specific menus and menu options discussed above are for illustrative purposes only and that the number, style, and structure of the menus and the various menu options can vary from those of the illustrated embodiment without departing from the scope or spirit of the present invention. For example, in one embodiment, the first stimulus delivery switch 24 and the second stimulus delivery switch 26 can be programmed to activate the same stimulus delivery device 12, whereas the first stimulus delivery switch 24 is associated with a vibration stimulus and the second stimulus delivery switch 26 is associated with an electrical stimulus such that the user is able to deliver a warning stimulus (the vibration stimulus) to the animal prior to delivering a corrective stimulus (the electrical stimulus). In another embodiment, the display 14 indicates the stimulus delivery device 12 to deliver the stimulus by providing a distinguishable backlighting corresponding to each stimulus delivery device 12. For example, when the first stimulus delivery device 12a is to deliver the customized stimulus, the display 14 provides a green backlighting, and when the second stimulus delivery device 12b is to deliver the customized stimulus, the display 14 provides a yellow backlighting. The user toggles among the various stimulus delivery devices 12 using the menu navigation control 16 when the animal training device 10 operates in the stimulus delivery mode. Accordingly, the user activates the desired stimulus delivery device 12 to the extent that the stimulus delivery device 12 delivers the customized stimulus by toggling to the corresponding backlighting and operating the stimulus delivery switch 18.

When the parameters of the customized stimuli have been satisfactorily defined by the user, the user sets the animal training device 10 to operate in the stimulus delivery mode. As previously discussed, the display 14 presents the defined parameters of each customized stimulus such that the parameters are visually associated with the corresponding stimulus delivery switch 18. Considering again FIG. 2a, in the illustrated embodiment, the customized stimulus corresponding to the first stimulus delivery switch 24 is an electrical stimulus having an intensity level of 73 that is to be delivered by the first stimulus delivery device 12a. Additionally, the customized stimulus corresponding to the second stimulus delivery switch 26 is a vibration stimulus having an intensity level of 21 that is to be delivered by the second stimulus delivery device 12b.

Considering again FIG. 1, the first processor 20 of the animal training device 10 generates a stimulus request signal for each customized stimulus. The stimulus request signal includes information indicative of the defined parameters of the customized stimulus. When operating in the stimulus delivery mode, the animal training device 10 transmits the stimulus request signal by way of the transmitter 22 in response to the corresponding stimulus delivery switch 18 being operated. In one embodiment, the stimulus delivery switch 18 is a manually operated switch operable by the user. However, it should be noted that the stimulus delivery switch 18 can be an automated switch that operates in response to a predefined event. For example, in one embodiment, the activation switch 18 cooperates with an animal containment system. In the illustrated embodiment, the stimulus delivery switches 18 are pressable buttons. As a result, when the user operates the first stimulus delivery switch 24, the first processor 20, by way of the transmitter 22, transits a first stimulus request signal including information indicative of the defined parameters of the customized stimulus associated with the first stimulus delivery switch 24. For the purpose of this discussion, the customized stimulus associated with the first stimulus delivery switch 24 is referred to as the first customized stimulus. Similarly, when the user operates the second stimulus delivery switch 26, the first processor 20, by way of the transmitter 22, transmits a second stimulus request signal including information indicative of the defined parameters of the customized stimulus associated with the second stimulus delivery switch 26. For the purpose of this discussion, the customized stimulus associated with the second stimulus delivery switch 26 us referred to as the second customized stimulus.

The stimulus delivery device 12 includes a receiver 28, a second processor 30, and a stimulus delivery mechanism 32, the second processor 30 being in electrical communication with the receiver 28 and the stimulus delivery mechanism 32. The receiver 28 is adapted to receive the stimulus request signal such that the second processor 30 receives the information indicative of the defined parameters of the customized stimulus. The second processor 30 determines the defined parameters and, if in accordance with the defined parameters, activates the stimulus delivery mechanism 32 such that it delivers the customized stimulus to the animal. Accordingly, the stimulus delivery mechanism 32 is adapted to the deliver all possible permeations of the customized stimulus. For example, in the illustrated embodiment, the stimulus delivery mechanism 32 is adapted to deliver an electrical, a vibration, and an audible stimulus, each of various intensities. More specifically, when the animal training device 10 transmits the first stimulus request signal and the first stimulus delivery device 12a receives the signal, the second processor 30 of the first stimulus delivery device 12a activates the stimulus delivery mechanism 32 of the first stimulus delivery device 12a such that it delivers an electrical stimulus having an intensity level of 73 to the animal carrying the first stimulus delivery device 12a. When the animal training device 10 transmits the first stimulus request signal and the second stimulus delivery device 12b receives the signal, the second processor 30 of the second stimulus delivery device 12b determines that the first stimulus delivery device 12a is defined as the device to deliver the first customized stimulus and takes no further action. Similarly, when the animal training device 10 transmits the second stimulus request signal and the first stimulus delivery device 12a receives the signal, the second processor 30 of the first stimulus delivery device 12a determines that the second stimulus delivery device 12b is defined as the device to deliver the second customized stimulus and takes no further action. When the animal training device 10 transmits the second stimulus request signal and the second stimulus delivery device 12b receives the signal, the second processor 30 of the second stimulus delivery device 12b activates the stimulus delivery mechanism 32 of the second stimulus delivery device 12b such that it delivers a vibration stimulus having an intensity level of 21 to the animal carrying the second stimulus delivery device 12b.

It should be noted that when the animal training device 10 is in communication with multiple stimulus delivery devices 12, the stimulus delivery devices 12 do not have to have identical stimulus delivery capabilities to remain within the scope and spirit of the present invention. However, when the stimulus delivery devices 12 do have differing stimulus delivery capabilities, the animal training device 10 must account for the differing capabilities when defining the customized stimuli. For example, if the first stimulus delivery device 12a is not capable of delivering a vibration stimulus, when the user selects the “First Stimulus Delivery Device” option from the “Stimulus Delivery Device” menu, the animal training device 10 does not present the “Vibration” option under “Stimulus Type” menu.

Although the above-discussed embodiment of the animal training device 10 includes a first and second stimulus delivery switch 24, 26, it should be noted that the animal training device 10 can have one or more stimulus delivery switches 18 without departing from the scope and spirit of the present invention. Additionally, although the above-discussed embodiment of the animal training device 10 operates with a first and second stimulus delivery device 12a, 12b, it should be noted that the animal training device 10 can operate with one or more stimulus delivery devices 12 without departing from the scope or spirit of the present invention.

From the foregoing description, those skilled in the art will recognize that an animal training device having the capability to activate a stimulus delivery device such that it delivers a customized stimulus to an animal having advantages over the prior art has been provided. More specifically, the animal training device includes a menu-driven user interface that enables a user to define the programmable parameters of a customized stimulus and to associate the customized stimulus with a stimulus delivery switch such that when the stimulus delivery switch is operated, the animal training device transmits a stimulus request signal, which includes information indicative of the defined parameters. The stimulus delivery device is responsive to the stimulus request signal to the extent that when the stimulus delivery device receives the stimulus request signal, it determines the defined parameters and delivers the customized stimulus to the animal.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. An animal training device adapted to activate a stimulus delivery device that is adapted to be carried by an animal, said animal training device comprising:
a display adapted to present a series of menus having menu options, the menu options corresponding to a parameter of a customized stimulus;
a menu navigation control operable by a user, said menu navigation control enabling the user to navigate the series of menus and to select the menu options, the selected menu options defining the parameter of the customized stimulus;
a transmitter adapted to transmit a stimulus request signal, the stimulus request signal including information indicative of the defined parameter of the customized stimulus, the stimulus delivery device being adapted to receive the stimulus request signal and to deliver the customized stimulus to the animal; and
a stimulus delivery switch operable by the user and associated with the customized stimulus, said transmitter transmitting the stimulus request signal in response to the operation of said stimulus delivery switch.

2. The animal training device of claim 1 wherein said display is a dot matrix LCD.

3. The animal training device of claim 1 wherein the parameter of the customized stimulus is a plurality of parameters.

4. The animal training device of claim 1 wherein the parameter of the customized stimulus includes the stimulus delivery device that delivers the customized stimulus.

5. The animal training device of claim 1 wherein the parameter of the customized stimulus includes the type of stimulus.

6. The animal training device of claim 1 wherein the parameter of the customized stimulus includes the intensity of the stimulus.

7. The animal training device of claim 1 wherein said menu navigation control includes pressable keys.

8. The animal training device of claim 1 wherein said menu navigation control is said display having touch-screen capabilities.

9. The animal training device of claim 1 wherein said animal training device is adapted to activate more than one stimulus delivery device.

10. The animal training device of claim 9 wherein said display provides a distinguishable backlighting for each of the more than one stimulus delivery device, the backlighting indicates the stimulus delivery device of the more than one stimulus delivery that is to be activated by said animal training device.

11. The animal training device of claim 1 wherein said stimulus delivery switch is a pressable button.

12. The animal training device of claim 1 comprising a plurality of stimulus delivery switches, each of said plurality of stimulus delivery switches being associated with a respective customized stimulus.

13. The animal training device of claim 12 comprising a first stimulus delivery switch and a second stimulus delivery switch, said first stimulus delivery switch being associated with a first customized stimulus, said second stimulus delivery switch being associated with a second customized stimulus, said transmitter transmitting a first stimulus request signal in response to the operation of the first stimulus delivery switch, the first stimulus request signal including information indicative of the defined parameter of the first customized stimulus, said transmitter transmitting a second stimulus request signal in response to the operation of the second stimulus delivery switch, the second stimulus request signal including information indicative of the defined parameter of the second customized stimulus.

14. The animal training device of claim 13 adapted to activate a first stimulus delivery device and a second stimulus delivery device, the first stimulus delivery device being responsive to the first stimulus request signal, the second stimulus delivery device being responsive to the second stimulus request signal.

15. An animal training device adapted to activate a stimulus delivery device that is adapted to be carried by an animal, said animal training device comprising:
a first processor;
a display in electrical communication with said first processor, said display adapted to present a series of menus having menu options, the menu options corresponding to one or more parameters of a customized stimulus;
a menu navigation control in electrical communication with said first processor, said menu navigation control enabling a user to navigate the series of menus and to select the menu options, the selected menu options defining the one or more parameters of the customized stimulus, said first processor generates a stimulus request signal having information indicative of the defined parameters of the customized stimulus;
a transmitter in electrical communication with said first processor, said transmitter being adapted to transmit the stimulus request signal, the stimulus delivery device being adapted to receive the stimulus request signal and to deliver the customized stimulus to the animal; and
a stimulus delivery switch in electrical communication with first processor, said stimulus delivery switch being associated with the customized stimulus, said transmitter transmitting the stimulus request signal in response to the operation of said stimulus delivery switch.

16. The animal training device of claim 15 wherein said stimulus delivery switch is manually operable by the user.

17. The animal training device of claim 15 wherein said stimulus delivery switch is an automated switch responsive to a predetermined event.

18. The animal training device of claim 15 comprising a plurality of stimulus delivery switches, each of said plurality of stimulus delivery switches being associated with a respective customized stimulus.

19. The animal training device of claim 15 wherein said animal training device is adapted to activate more than one stimulus delivery device.

20. The animal training device of claim 19 wherein said display provides a distinguishable backlighting for each of the more than one stimulus delivery device, the backlighting indicates the stimulus delivery device of the more than one stimulus delivery that is to be activated by said animal training device.
